(19) United States
(12) Patent Application Publication
(10) Pub. No.: US 2012/0113247 A1
(43) Pub. Date: May 10, 2012

(54) Lighting Device For Alignment And Exposure Device Having The Same

(75) Inventors: Tugunori Tanemura, Tokyo (JP); Yu Nakajima, Tokyo (JP); Jun Nagoya, Tokyo (JP); Yoshiyuki Oya, Tokyo (JP)

(73) Assignee: ADTEC ENGINEERING CO., LTD., Tokyo (JP)

(21) Appl. No.: 13/272,690

(22) Filed: Oct. 13, 2011

(30) Foreign Application Priority Data
Nov. 5, 2010 (JP) 2010-248117

(51) Int. Cl. H04N 7/18; H05B 37/02

(52) U.S. Cl. 348/87; 315/158; 348/E07.085

(57) ABSTRACT

A ring shape lighting device, used for lighting the mark around the CCD camera, has a lighting device, a lighting brightness control device, a lighting height control device, a lighting color control device and a controller. The controller controls these devices and detects the marks using the CCD camera, by changing the lighting brightness at 1 percent step from 1 to 100 percent with different combinations of lighting height and lighting color. The device detects the mark contrasts using a contrast detection/determination device and detects the variance using a variance detection/determination device. The device then determines the best lighting condition based on the variance.

### BACKGROUND OF THE INVENTION

The invention relates to a lighting device for alignment and an exposure device having the lighting device.

### RELATED BACKGROUND ART

The photolithography method has been applied in manufacturing a printed circuit board, wherein a prescribed pattern is photographically imprinted by an exposure device on a surface of a substrate coated with photosensitive materials such as photo resist, thereafter the pattern is formed on the substrate by etching process.

When exposing by the exposure device, the photo mask and the circuit board must be aligned, usually by using an image detecting device like as a CCD camera and a lighting device for photographing.

A pattern of the printed circuit has been becoming minute and a laser via that can make a minute hole has been utilizing and an alignment mark on the printed circuit board is now usually made by a laser via device that makes a minute hole.

Furthermore high-mix low-volume production has been more employing in the production of the printed circuit board and the type of the resist on the boards and the area of the resist varies depending on type of board.

Said alignment marks on the boards made by the laser via devices have a little difference from the surfaces of the boards and the alignment marks cannot be photographed with sufficient accuracy. Further other conditions of the boards vary due to said high-mix low-volume production and it is one of the reasons which makes the accurate photography of the alignment marks difficult.

To accurately recognize the marks, there have been proposed many methods and devices, for example a method and device for adjusting brightness of lighting, or height of the lighting or for changing light color.

### RELATED PRIOR ARTS

1. Laid open No. 2006-251571
2. Laid open No. H10-62134
3. Laid open No. 2004-272774

### SUMMARY OF THE INVENTION

However the device and method for adjusting lighting brightness is not sufficient to accurately detect alignment marks because the prior arts just select the lighting brightness which can provide the highest contrast between the marks and the surface of the board.

The lighting device for alignment of the invention is for lighting a board mark provided on a printed circuit board and a mask mark provided on a mask when aligning the printed circuit board and the mask based on the board mark and the mask mark by recognizing the board mark and the mask mark by an image recognition device. The lighting device comprises an lighting brightness control device for changing brightness of the lighting device, a contrast detection device for detecting a contrast between the board mark and the printed circuit board and for detecting a contrast between the mask mark and the printed circuit board, a variance detection device for detecting variance of positions such as coordinates of centers of the board mark and the mask mark recognized plural times by the image recognition device, a lighting condition decision device for determining appropriate lighting brightness as appropriate lighting condition among plurality of brightness changed by said lighting brightness control device based on contrast detected by said contrast detection device and variance detected by said variance detection device.

The lighting device of the invention decides the best lighting condition based on not only brightness but also variances of positions of the mask marks and board marks actually recognized by the mark recognition device. Thus such determined lighting condition is reliable.

For parameter of the lighting condition, the height of lighting and color of lighting can be added.

### BRIEF DESCRIPTION OF THE DRAWINGS

FIG. 1 is a schematic view of an embodiment of the invention.

FIG. 2 is a block diagram of the embodiment.

FIG. 3 is a part view of the embodiment.

FIG. 4 is an explanatory view of the embodiment.

FIG. 5 is a flow chart showing an operation of the embodiment.

FIG. 6 is an explanatory view showing the operation of the embodiment.

FIG. 7 is an explanatory view showing the operation of the embodiment.

FIG. 8 is an explanatory view showing the operation of the embodiment.

FIG. 9 is a flow chart showing an operation of the embodiment.

### DETAILED DESCRIPTION OF THE PREFERRED EMBODIMENT

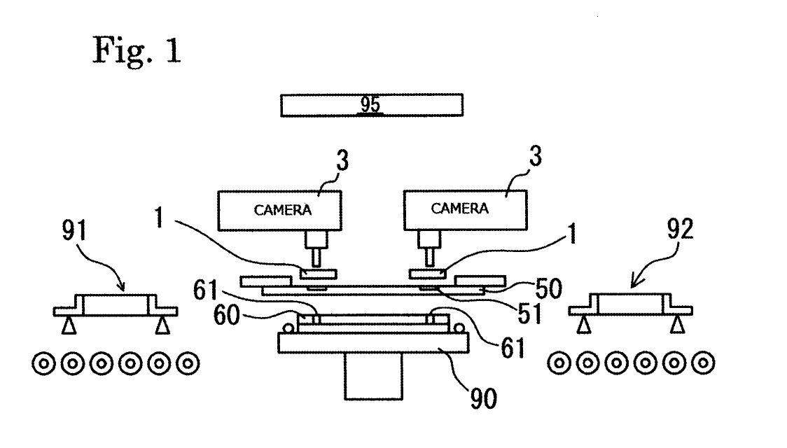

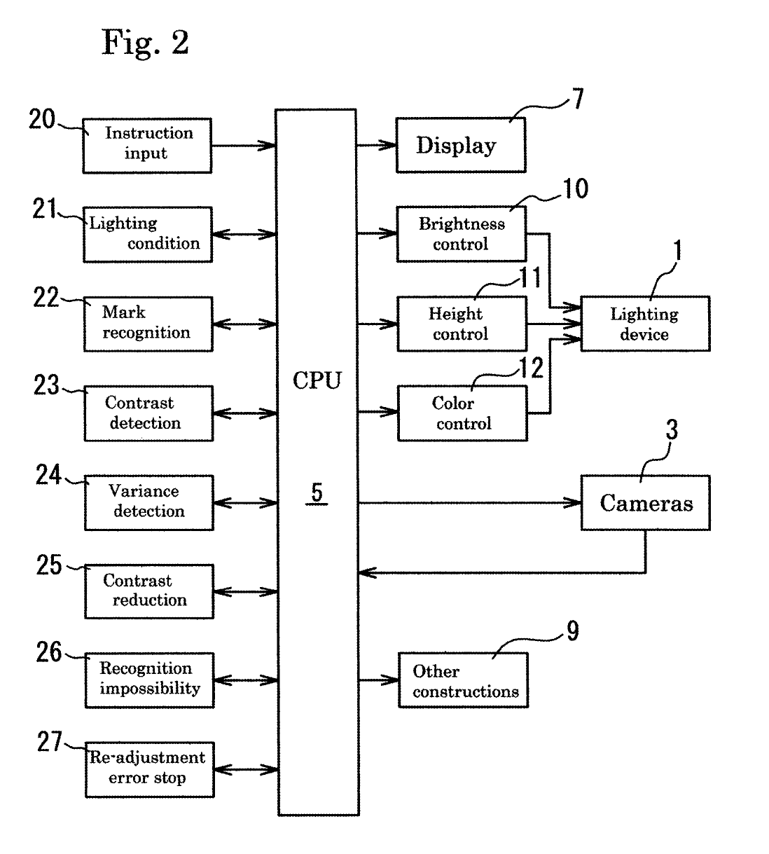

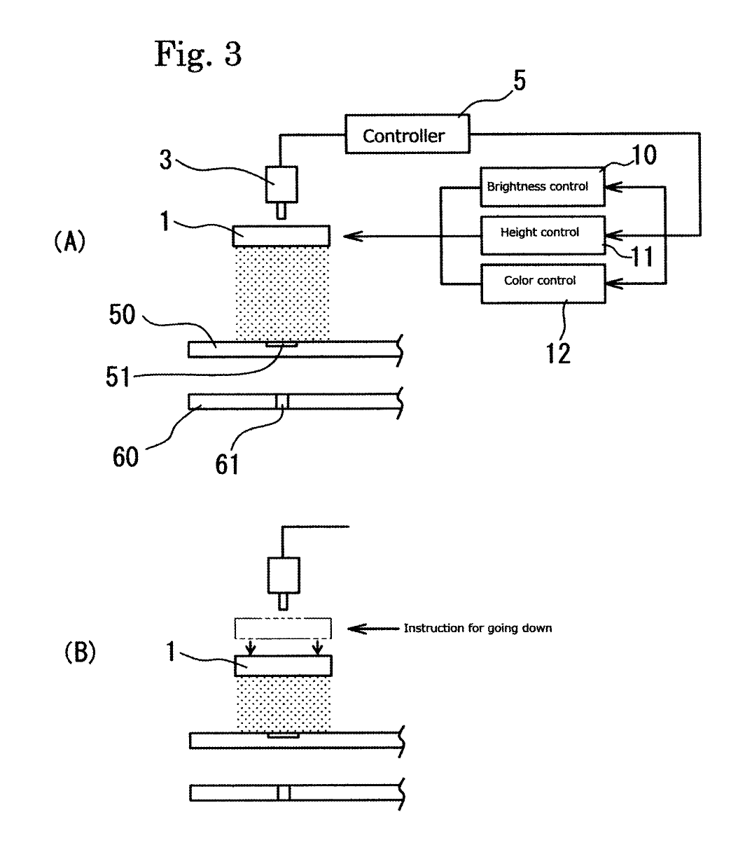

The invention will now be described in reference to the attached drawings. FIG. 1 shows an outline of an exposure device for manufacturing printed circuit boards. FIG. 2 shows a block diagram and FIG. 3 shows detail of lighting device 1.

A printed circuit board 60 conveyed on a exposure stage 90 by a carry-in device 91 is exposed with a pattern depicted on a mask 50 by a light source 95 and then sent to a next procedure by a carry-out device 92.

Four CCD cameras 3 are set on positions corresponding to four corners of the printed circuit board 60 above the mask 50. Before exposure an alignment between the mask 50 and the printed circuit board 60 is conducted using mask marks 51 depicted on the corners of the mask 50 and board marks 61 formed on the corners of the printed circuit board 60. An exposure stage 90 can be moved in XYZ and θ directions and the mask mark 51 and the board mark 61 are lighted up by a lighting device 1. The CCD cameras 3 photograph the mask mark 51 and the counter mark 61 respectively and the exposure stage 90 is moved so as to overlap the mask mark 51 and the counter board mark 61.

The lighting device 1 is a ring shaped lighting device which illuminates the marks around the CCD cameras 3.

The lighting device 1 is as shown in FIGS. 2 and 3 provided with a lighting brightness control device 10, a lighting height control device 11 and a lighting color control device 12 which are controlled by a controller 5. 7 is a display and 9 is a other construction, which are controlled by the controller 5 as well.

The lighting brightness control device 10 can successively change the brightness of the lighting device 1 by Pulse Width Modulation (PWM).

The lighting height control device 11 has a driving mechanism (not shown) that changes an elevation of the position of the lighting device 1 and it changes the height of the lighting device 1, i.e. distance between the lighting device 1 and the printed circuit board 60 or the mask 50. The change of the height may be successively changed or step by step changed, in the embodiment two heights position of the lighting device 1 can be selected. FIG. 3 A shows the lighting device 1 set at the higher position (longer distance from the printed circuit board 60 of the mask 50) and FIG. 3 B shows the lighting device 1 set at the lower position.

The lighting color control device 12 selects one of lights having different wave length, in the embodiment the lighting color control device 12 can select one of green, red and near-infrared light.

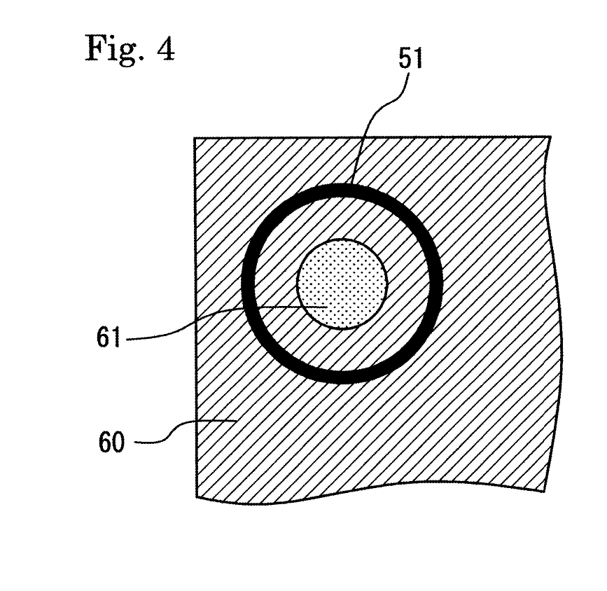

One example of the mask mark 51 and the board mark 61 photographed by the CCD camera 3 is shown in FIG. 4. The mask mark 51 is a black ring and the board mark 61 is a via hole photographed as a black circle.

Contrast between a surface of the printed circuit board 60 and the mask mark 51 or the board mark 61 (referred to as “mark contrast” hereinafter) is needed sufficient to recognize and photograph the mask mark 51 and the board mark 61 in order to perform reliable alignment.

The controller 5 controls the lighting brightness control device 10, and additionally controls the lighting height control device 11 and/or lighting color control device 12 to change the brightness, the color and the height of the lighting device 1 and decides the most appropriate lighting condition that can provide a good mark contrast and a reliable recognition of the marks.

At least the changing of the brightness by the lighting brightness control device 10 is necessary to obtain the best brightness. In addition, the appropriate height of the lighting device 1 can be obtained that can provide the best mark contrast by changing the height of the lighting device 1 with the lighting height control device 11.

Further the appropriate color of the lighting that provide the best mark contrast, may be obtained by changing the color with the lighting color control device 12.

In the embodiment, the controller 5 controls the lighting brightness control device 10, the lighting height control device 11 and the lighting color control device 12 and makes a combination of the brightness, the height of the lighting and the lighting color that can provide the best mark recognition.

The operation for making the combination of the brightness, the height of the lighting and the lighting color that can provide the best mark recognition can be done when setting the positions of the CCD cameras 3, or when aligning the printed circuit board 60 and the mask 50.

As shown in FIG. 2, the controller 5 comprising mainly CPU recognizes the mask mark 51 and board mark 61 through a mark recognition device 22 based on image signals from the CCD camera 3 and detects and determines the mark contrasts between the mask mark 51 and the surface of the printed circuit board 60 and between the board mark 61 and the surface of the printed circuit board 60. The controller 5 further determine the best lighting condition with a lighting condition decision device 21 based on said mark contrast and a variance value from a variance detection/determination device 24.

The detection and the determination of the contrast is conducted by calculating an average value of difference of light and shade at a border of the board mark 61 and the surface of the printed circuit board 60 and a border of the mask mark 51 and the surface of the printed circuit board 60. The average value will be compared with a certain threshold value and when the average value is less than the threshold, the controller 5 and the contrast detection/determination device 23 determine there is no contrast.

The best lighting condition means the combination of the brightness, the height and the color of the lighting device 1 that can provide low variance of the positions of the marks actually recognized.

After determining the best condition of lighting by the lighting condition decision device 21, the alignment is conducted with the determined condition of lighting. The mask mark 51 and the board mark 61 are photographed with the determined lighting condition and the mask mark 51 and the board mark 61 are aligned, then the exposure is conducted by the exposure light from the exposure light source 95.

The controller 5 is further connected with a contrast reduction detector 25, and a mark recognition impossibility detector 26. The contrast reduction detector 25 detects the drop of the mark contrast under the condition determined by the lighting condition decision device 21 and the mark recognition impossibility detector 26 detects that the recognition of the marks becomes impossible.

There is further a re-adjustment/error-stop device 27 connected to the controller 5. The re-adjustment/error-stop device 27 selects whether the process for obtaining the best condition of the lighting should be done again or the exposure operation should be stopped when said drop of the mark contrast and/or the impossibility of the recognition of the marks happen.

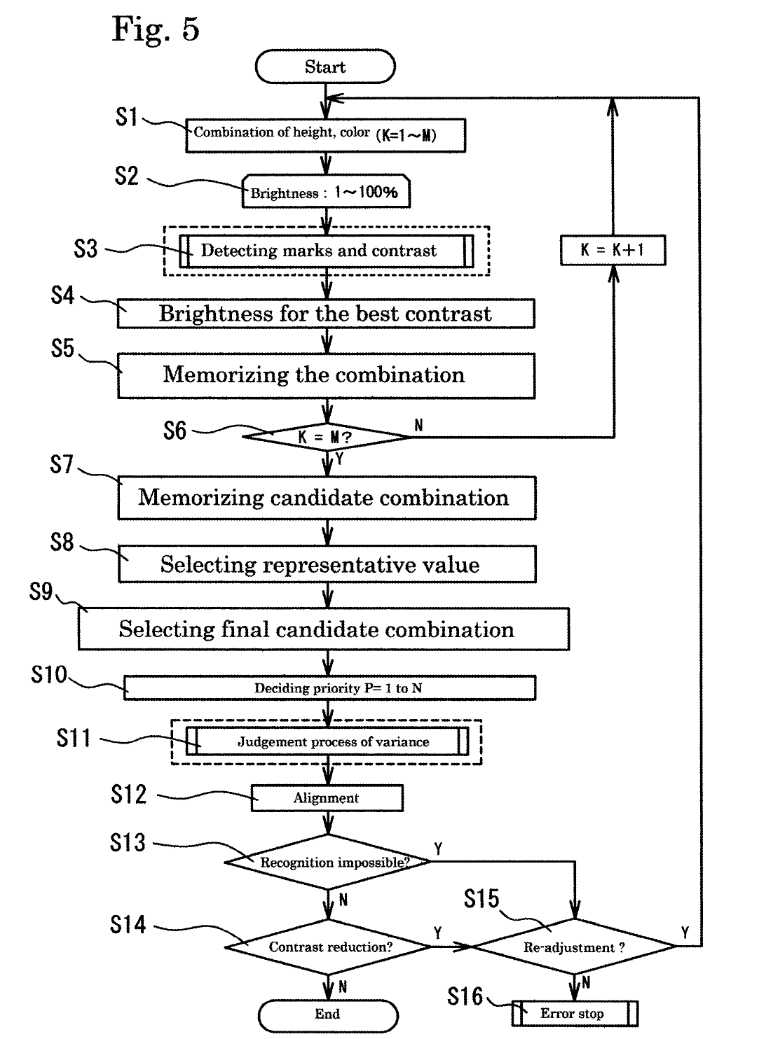

The operation of the embodiment will be explained with a flow chart shown in FIG. 5.

For the combinations K=1−M of the lighting heights and the lighting colors, the brightness of the lighting is changed from 1 percent to 100 percent at 1 percent step.

At each brightness, the marks are detected by the CCD cameras 3 and the mark recognition device 22 and the mark contrasts are detected by the contrast detection/determination device 23 (steps S1-S3).

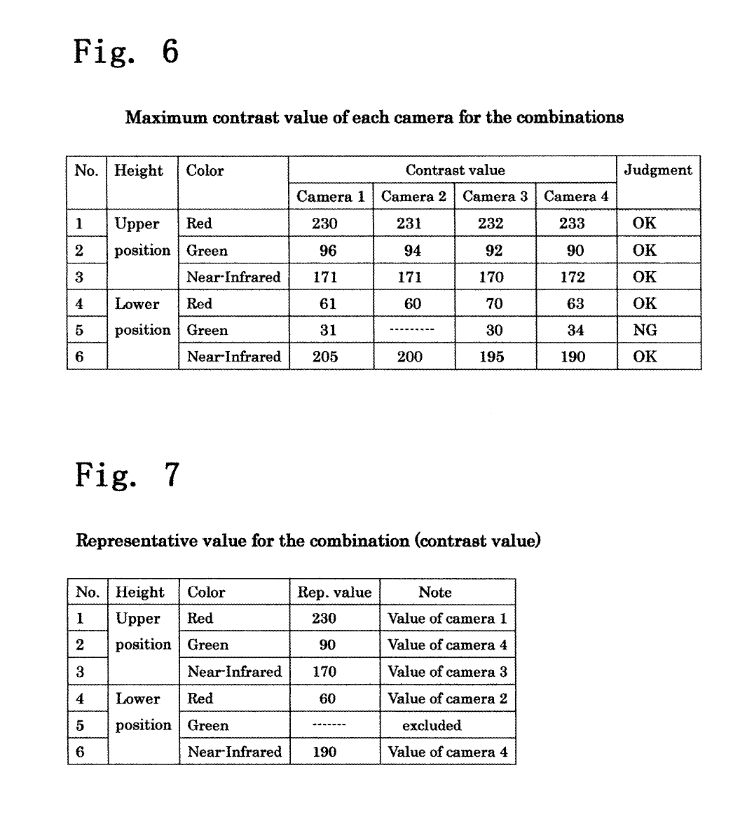

In the embodiment, the mark contrasts are assessed for the combinations of No. 1 to 6 of the lighting heights and the colors as shown in FIG. 6.

In the embodiment, the mask marks 51 and the board marks 61 are set on the four corners of the mask 50 and the printed circuit board 60 respectively and the four CCD cameras 3 of cameras 1 to 4 are used for alignment.

Said percentage of the lighting brightness means duty ratio in PWM (Pulse Width Modulation) control.

Then the lighting brightness that provides the best mark contrast in the combination 1 to 6 and the camera 1 to 4 is determined at the lighting condition decision device 21 (step S4), and the combination of the brightness, the height and the color is memorized as a qualified combination (step S5).

After all the combinations are tested (step S6), such combination where even one camera among the cameras 1 to 4 cannot provide the mark contrast is determined as NG, and other combinations are determined and memorized as the candidate combination (step S7). For example, as shown in FIG. 6, the combination No. 5 cannot provide the mark contrast at the camera 2. That is, for all the percentage of 1 to 100 of the lighting contrast the combination No. 5 cannot obtain the mark contrast. Then the No. 5 combination is excluded and other combinations become candidate combinations.

Next the lowest value in each candidate combination No. 1 to 6 for the cameras 1 to 4 is selected as a representative value as shown in FIG. 7. The combination No. 5 was excluded from the candidate combinations as mentioned.

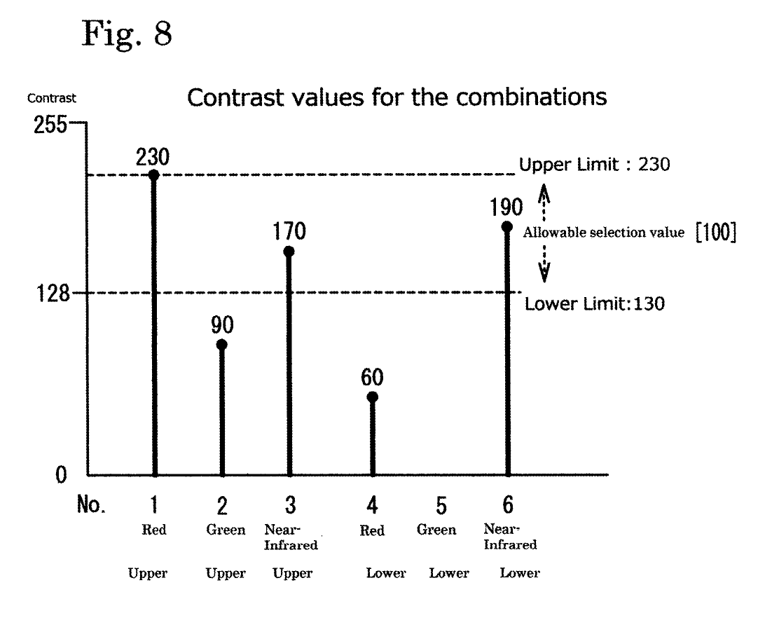

Then final candidates are selected from the candidates in a certain area (allowable selection value of lighting condition) of values from the biggest value among the representative values (step S9). As shown in FIG. 8, the biggest value among the representative values is 230 of the combination No. 1, and the certain are (allowable selection value of lighting condition) is set at 100 in the embodiment. The combination, the representative value of which is more than 130 is selected as the final candidate combination. In the example, the combinations No. 1, 3 and 6 are selected as the final candidates.

Next the priority P=1 to N is decided for the final candidate combinations (step S10). In the embodiment the priority is set at high rank in order of the height > the color and in order of the upper position of the height of the lighting > the lower position. With respect to lighting color, the priority set higher in order of green > red > near-infrared.

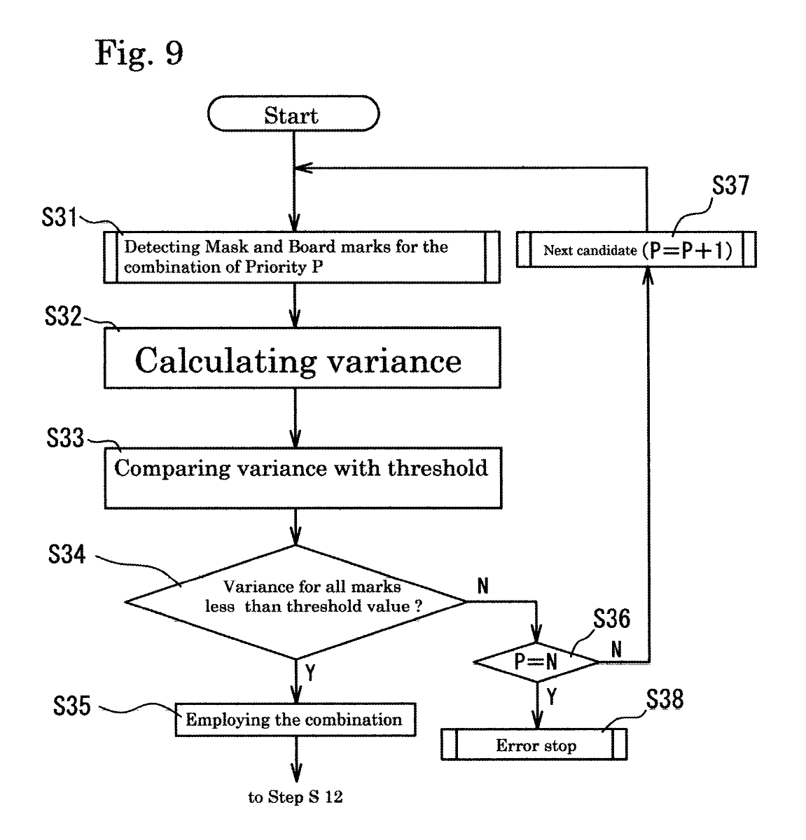

Next the judgment process of the variance of the coordination of the mark center is conducted in order of said priority (step S11). The process will be explained referring to FIG. 9.

With respect to the combination of the priority P, the mask mark 51 and the board mark 61 are detected plural times by the cameras 1 to 4 respectively (step S31) and the variance of the coordinates of the centers of the mask mark 51 and the board mark 61 are calculated for the cameras respectively (step S32).

The variance value is compared with a certain threshold value (step S33), and it is judged if all the variance of the positions of the mask mark 51 and the board mark 61 for the cameras respectively is less than the threshold value (step S34). On the case of all the variance is less than the threshold, the lighting condition decision device 21 decides the combination as qualified condition and employ the combination (step S35), and move to step S12 of FIG. 5.

At step S34, if there is one or more value of variance not less than the threshold in all the camera, the mask mark 51 and the board mark 61, then the same operation will be repeated for the next priority P=P+1 (steps S36, 37).

After the operation is done for all the priority P=N and if there is no variance less than the threshold for all the camera, the mask mark 51 and the board mark 61, then the device will be stopped.

At step S11 in FIG. 5, if the combination where all the variance are less than the threshold for all the camera, the mask mark 51 and the board mark 61, then the alignment will be conducted with the combination (step S12).

In the alignment process, when the mark recognition impossibility detector 26 detects that the mark recognition becomes impossible, the controller 5 checks if re-adjustment mode is set by the re-adjustment/error stop device 27 (step S15). If it is set, the controller 5 returns step S1 and repeat the same operation. If it is not set, the controller 5 stops the operation (step S16).

Further, the controller 5 moves to step S15 as well when detecting the decline of the mark contrast by the contrast reduction detector 25 (step S14).

### EXPLANATION OF SYMBOLS

1: lighting device, 3: CCD camera, 5: controller, 7: display, 9: other construction, 10: lighting brightness control device, 11: lighting height control device, 12: lighting color control device, 20: instruction input device, 21: lighting condition decision device, 22: mark recognition device, 23: contrast detection/determination device, 24: variance detection/determination device, 25: contrast reduction detector, 26: mark recognition impossibility detector, 27: re-adjustment/error-stop device, 50: mask, 51: mask mark, 60: printed circuit board, 61: board mark, 90: exposure stage, 91: carry-in device, 92: carry-out device, 95: exposure light source.

What is claimed is:

1: A lighting device for alignment for lighting a board mark 61 provided on a printed circuit board 60 and a mask mark 51 provided on a mask 50 when aligning the printed circuit board 60 and the mask 50 based on the board mark 61 and the mask mark 51 by recognizing the board mark 61 and the mask mark 51 by an image recognition device, comprising:
a lighting brightness control device for changing brightness of a lighting device,
a contrast detection device for detecting contrast between the board mark and the printed circuit board and contrast between the mask mark and the printed circuit board,
a variance detection device for detecting variance of positions of the board mark and the mask mark recognized plural times by the image recognition device,
a lighting condition decision device for determining appropriate lighting brightness as appropriate lighting condition among plurality of brightness changed by said lighting brightness control device based on contrast detected by said contrast detection device and variance detected by said variance detection device.

2: An lighting device for alignment for lighting a board mark provided on a printed circuit board and a mask mark provided on a mask when aligning the printed circuit board and the mask based on the board mark and the mask mark by recognizing the board mark and the mask mark by an image recognition device, comprising:
a lighting brightness control device for changing brightness of the lighting device,
a lighting height control device for changing lighting distance of the lighting device against said printed circuit board and said mask,
a contrast detection device for detecting contrast between the board mark and the printed circuit board and contrast between the mask mark and the printed circuit board,
a variance detection device for detecting variance of positions of the board mark and the mask mark recognized plural times by the image recognition device,
a lighting condition decision device for determining appropriate combination as appropriate lighting condition among plurality of combination of brightness changed by said lighting brightness control device and lighting distance changed by said lighting height control device based on contrast detected by said contrast detection device and variance detected by said variance detection device.

3: An lighting device for alignment for lighting a board mark provided on a printed circuit board and a mask mark provided on a mask when aligning the printed circuit board and the mask based on the board mark and the mask mark by recognizing the board mark and the mask mark by an image recognition device, comprising:
a lighting brightness control device for changing brightness of the lighting device,
a lighting height control device for changing lighting distance of the lighting device against said printed circuit board and said mask,
a lighting color control device for changing lighting color of the lighting device,
a contrast detection device for detecting contrast between the board mark and the printed circuit board and contrast between the mask mark and the printed circuit board,
a variance detection device for detecting variance of positions of the board mark and the mask mark recognized plural times by the image recognition device,
an lighting condition decision device for determining appropriate combination as appropriate lighting condition among plurality of combination of brightness changed by said lighting brightness control device, lighting distance changed by said lighting height control device and lighting color changed by said lighting color control device based on contrast detected by said contrast detection device and variance detected by said variance detection device.

4: A lighting device for alignment as claimed in claim 1, wherein:
Said lighting condition decision device at first determines candidates for appropriate lighting condition based on contrast detected by said contrast detection device and next determines said appropriate lighting condition among the candidates based on variance detected by said variance detection device.

5: An exposure device having the lighting device for alignment as claimed in claim 1.

6: A lighting device for alignment as claimed in claim 2, wherein:
Said lighting condition decision device at first determines candidates for appropriate lighting condition based on contrast detected by said contrast detection device and next determines said appropriate lighting condition among the candidates based on variance detected by said variance detection device.

7: An exposure device having the lighting device for alignment as claimed in claim 2.

8: A lighting device for alignment as claimed in claim 3, wherein:
Said lighting condition decision device at first determines candidates for appropriate lighting condition based on contrast detected by said contrast detection device and next determines said appropriate lighting condition among the candidates based on variance detected by said variance detection device.

9: An exposure device having the lighting device for alignment as claimed in claim 3.
